(19) United States
(12) Patent Application Publication
(10) Pub. No.: US 2026/0350093 A1
(43) Pub. Date: Nov. 5, 2026

(54) DATA PARSING AGENT FOR A CONTEXT-SIZE RESTRICTED AI MODEL

(71) Applicant: Juniper Networks, Inc., Sunnyvale, CA (US)

(72) Inventors: Jeffrey S. Marshall, Santa Clara, CA (US); Kartik Krishnan S Iyyer, Livermore, CA (US); Mansi Joshi, San Jose, CA (US)

(21) Appl. No.: 19/467,992

(22) Filed: Feb. 3, 2026

Related U.S. Application Data
(60) Provisional application No. 63/799,076, filed on May 2, 2025.

(51) Int. Cl. G06F 16/835

(52) U.S. Cl. CPC G06F 16/8373

(57) ABSTRACT

Techniques are disclosed for using large data sets as an input to an Artificial Intelligence (AI) model, such as a Large Language Model (LLM), even where a size of such data sets exceed a context size of the AI model. In one example, a computing system receives a natural language query from a user device. The computing system obtains raw data from one or more Application Programming Interfaces (APIs). The computing system obtains parsing criteria and applies the parsing criteria to the raw data obtained from the one or more APIs to produce parsed data. A size of the parsed data is less than the context size of the AI model. The computing system provides, to the AI model, an input specifying the natural language query and the parsed data to obtain a natural language answer to the natural language query, and outputs the natural language answer.

This application claims the benefit of U.S. Provisional Patent Application No. 63/799,076, filed 2 May 2025, the entire contents of which is incorporated herein by reference.

### TECHNICAL FIELD

This disclosure generally relates to Artificial Intelligence (AI) models.

### BACKGROUND

A computer network is a collection of interconnected computing devices that can exchange data and share resources. A variety of devices operate to facilitate communication between the computing devices. For example, a computer network may include routers, switches, gateways, firewalls, and a variety of other devices to provide and facilitate network communication.

### SUMMARY

In general, the disclosure describes techniques for using an Artificial Intelligence (AI) model, such as a Large Language Model (LLM), for analysis of data obtained from one or more Application Programming Interfaces (APIs) data of a computing system, even where such data exceeds a context size (also referred to herein as a context limit, input limit, or maximum input size) of the AI model. For example, a computing system as described herein includes a plurality of APIs for interfacing with the computing system, each of which employs a different API schema. The computing system receives a natural language query from a user device. The computing system may optionally provide an input specifying the natural language query and a description of the plurality of APIs to an AI model to obtain, from the AI model, a selection of one or more APIs of the plurality of APIs that may include information relevant to answering the natural language query and one or more parameters for invoking the selected one or more APIs. In other examples, the computing system receives a selection of the one or more APIs and the one or more parameters from a user, such as an administrator of the computing system, via a user device.

The computing system invokes the selected one or more APIs with the one or more parameters to obtain raw data. Typically, the raw data exceeds a context size of the AI model. In addition, the computing system may optionally provide an input specifying the natural language query and one or more schemas for the one or more APIs to obtain, from the AI model, parsing criteria. In other examples, the computing system receives the parsing criteria from a user device operated by a user, such as an administrator for the selected one or more APIs. The computing system applies the parsing criteria to the raw data obtained from the one or more APIs to produce parsed data. The parsed data is less than or equal to the context size of the AI model. In some examples, the parsing criteria comprises filtering criteria for filtering the raw data into filtered data that is less than or equal to the context size of the AI model and includes data that is of a higher relevance to the AI model.

As described herein, the term “parsing criteria” is used to describe criteria that may be applied to identify or recognize portions of raw data obtained the one or more APIs that match, belong to, or otherwise fulfill the conditions specified by the parsing criteria. An example of “parsing criteria” described herein is “filtering criteria.” As described herein, the term “filtering criteria” is a subset of parsing criteria that used to describe criteria that may be applied to include or exclude portions of raw data obtained the one or more APIs that match, belong to, or otherwise fulfill the conditions specified by the filtering criteria. In addition to filtering criteria, parsing criteria, as envisioned herein, may include other types of criteria or operations that may be applied to the raw data to reduce its size, such as clustering criteria that may cluster similar portions of the raw data to one another, aggregation or summarization criteria that enable distilling the raw data into a smaller, less duplicative data set, or merging criteria to merge similar portions of the raw data into a smaller dataset.

The computing system provides an input specifying the natural language query and the parsed data to the AI model to obtain, from the AI model, a natural language answer to the natural language query. For example, the natural language answer may provide troubleshooting information about a computing system or networking system employing the plurality of APIs, assist in root cause identification of a failure within the computing system, or provide health or status information for the computing system. The computing system outputs, to an output device, the natural language answer.

The techniques of the disclosure may provide specific improvements to the computer-related field of root cause analysis of computer networks that may have one or more practical applications. For example, conventionally, an LLM may be used to identify what APIs (and corresponding input parameters) should be invoked to produce data needed to answer a query from a user device. However, the resultant data may exceed a context size of the LLM, and so may be unusable as an input to the LLM. The techniques of the disclosure may enable a system to parse or filter the data obtained from API invocation such that the data may be provided as input to LLM for analysis. In this fashion, the techniques of the disclosure may enable a context size-limited LLM to perform analysis of data obtained from APIs for, e.g., troubleshooting of computer networks, root cause identification, etc., even where such data exceeds the context-size of the LLM. Moreover, the techniques of the disclosure may leverage the LLM itself to identify relevant portions of the data obtained from the APIs and parse or filter raw data obtained from the APIs so as to obtain the relevant data for provision to the LLM for analysis. Thus, a system as described herein may be more flexible than other conventional tool invocation systems or function calling systems that rely on LLMs. In addition, by providing smaller data sets with more relevant data than conventional systems are able, a system as described herein may increase the accuracy and usefulness of the response from the LLM in answering a user's query over such conventional systems.

In one example, this disclosure describes a computing system comprising: processing circuitry in communication with storage media, the processing circuitry configured to: obtain parsing criteria that is based on a natural language query received from a user device; apply the parsing criteria to raw data obtained from one or more Application Programming Interfaces (APIs) to produce parsed data; provide, to an Artificial Intelligence (AI) model, an input including (1) the natural language query received from the user device and (2) the parsed data to obtain a natural language answer to the natural language query; and output the natural language answer.

In another example, this disclosure describes a method comprising: obtaining, by processing circuitry of a computing system, parsing criteria that is based on a natural language query received from a user device; applying, by the processing circuitry, the parsing criteria to raw data obtained from one or more Application Programming Interfaces (APIs) to produce parsed data; providing, by the processing circuitry, to an Artificial Intelligence (AI) model, an input including (1) the natural language query received from the user device and (2) the parsed data to obtain a natural language answer to the natural language query; and outputting, by the processing circuitry, the natural language answer.

In another example, this disclosure describes non-transitory, computer-readable media comprising instructions that, when executed, cause processing circuitry to: obtain parsing criteria that is based on a natural language query received from a user device; apply the parsing criteria to raw data obtained from one or more Application Programming Interfaces (APIs) to produce parsed data; provide, to an Artificial Intelligence (AI) model, an input including (1) the natural language query received from the user device and (2) the parsed data to obtain a natural language answer to the natural language query; and output the natural language answer.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example network system, in accordance with one or more aspects of the techniques described in this disclosure.

FIG. 2 is a block diagram illustrating a system in accordance with one or more aspects of the disclosure.

FIG. 3 is a block diagram illustrating a root cause analysis pipeline, in accordance with one or more aspects of the disclosure.

FIG. 4 is a block diagram illustrating an example computing system, in accordance with techniques described in this disclosure.

FIG. 5A is a flowchart illustrating an example operation in accordance with techniques described in this disclosure.

FIG. 5B is a flowchart illustrating an example operation in accordance with techniques described in this disclosure.

FIG. 6 is a block diagram illustrating an example system for performing function calling in accordance with techniques described in this disclosure.

FIG. 7 is a block diagram illustrating an example of the context-size agent of FIG. 6 in further detail, in accordance with techniques described in this disclosure.

FIG. 8 is a block diagram illustrating the example system for performing function calling of FIG. 6 in further detail, in accordance with techniques described in this disclosure.

Like reference characters refer to like elements throughout the figures and description.

### DETAILED DESCRIPTION

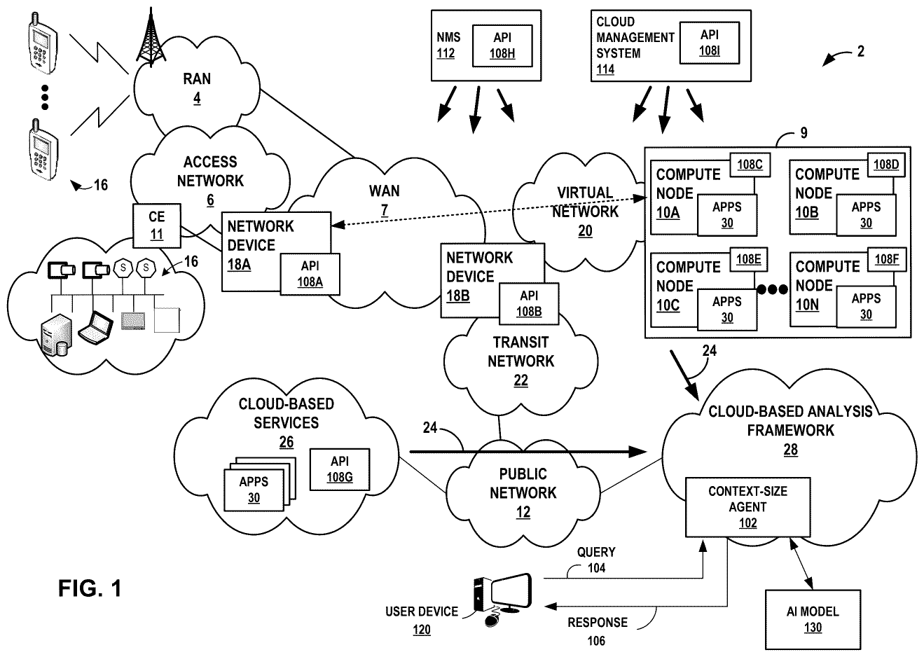

FIG. 1 is a block diagram illustrating an example cloud-based analysis framework, in accordance with one or more aspects of the techniques described in this disclosure. Network system 2 may provide packet-based network services to subscriber devices 16. That is, network system 2 may provide authentication and establishment of network access for subscriber devices 16 such that a subscriber device may begin exchanging data packets with public network 12, which may be an internal or external packet-based network such as the Internet.

In the example of FIG. 1, network system 2 comprises access network 6 that provides connectivity to public network 12 via wide area network 7 (hereinafter, “WAN 7”). WAN 7 and public network 12 may provide packet-based services that are available for request and use by subscriber devices 16. As examples, WAN 7 and/or public network 12 may provide bulk data delivery, voice over Internet protocol (VoIP), Internet Protocol television (IPTV), Short Messaging Service (SMS), Wireless Application Protocol (WAP) service, or customer-specific application services. Public network 12 may comprise, for instance, a local area network (LAN), a wide area network (WAN), the Internet, a virtual LAN (VLAN), an enterprise LAN, a layer 3 virtual private network (VPN), an Internet Protocol (IP) intranet operated by the service provider that operates access network 6, an enterprise IP network, or some combination thereof. In various examples, public network 12 is connected to a public WAN, the Internet, or to other networks. Public network 12 executes one or more packet data protocols (PDPs), such as IP (IPv4 and/or IPv6), X.25 or Point-to-Point Protocol (PPP), to enable packet-based transport of public network 12 services.

In general, subscriber devices 16 connect to network devices 18A-18B (collectively, “network devices 18”) via access network 6 to receive connectivity to subscriber services for applications hosted by public network 12. A subscriber may represent, for instance, an enterprise, a residential subscriber, or a mobile subscriber. Subscriber devices 16 may be, for example, personal computers, laptop computers or other types of computing devices positioned behind customer equipment (CE) 11, which may provide local routing and switching functions. Each of subscriber devices 16 may run a variety of software applications, such as word processing and other office support software, web browsing software, software to support voice calls, video games, video conferencing, and email, among others. For example, subscriber device 16 may be a variety of network-enabled devices, referred generally to as “Internet-of-Things” (IoT) devices, such as cameras, sensors (S), televisions, appliances, etc. In addition, subscriber devices 16 may comprise mobile devices that access the data services of network system 2 via a radio access network (RAN) 4. Example mobile subscriber devices include mobile telephones, laptop or desktop computers having, e.g., a wireless card, wireless-capable netbooks, tablets, video game devices, pagers, smart phones, personal data assistants (PDAs) or the like.

A network service provider operates, or in some cases leases, elements (e.g., network devices-not shown in the example of FIG. 1) of access network 6 to provide packet transport between subscriber devices 16 and network device 18A. Access network 6 represents a network that aggregates data traffic from one or more of subscriber devices 16 for transport to/from WAN 7 of the service provider. Access network 6 includes network nodes that execute communication protocols to transport control and user data to facilitate communication between subscriber devices 16 and network device 18A. Access network 6 may include a broadband access network, a wireless LAN, a public switched telephone network (PSTN), a customer premises equipment (CPE) network, or other type of access network, and may include or otherwise provide connectivity for cellular access networks, such as a radio access network (RAN), e.g., RAN 4. Examples of the RAN include networks conforming to a 5th Generation (5G) mobile network, 4th Generation (4G) mobile network Universal Mobile Telecommunications System (UMTS) architecture, an evolution of UMTS referred to as Long Term Evolution (LTE), 5G including enhanced mobile broadband, mobile IP standardized by the Internet Engineering Task Force (IETF), as well as other standards proposed by the 3rd Generation Partnership Project (3GPP), 3rd Generation Partnership Project 2 (3GGP/2) and the WiMAX forum.

Network device 18 may each be a customer edge (CE) router, a provider edge (PE) router, Software-defined Wide Area Network (SD-WAN) edge device, service device, network appliance, a server executing virtualized network functions, or other computing device that provides connectivity between networks, e.g., access network 6 and public network 12, or network services. WAN 7 offers packet-based connectivity to subscriber devices 16 attached to access network 6 for accessing public network 12 (e.g., the Internet). WAN 7 may represent a public network that is owned and operated by a service provider to interconnect a plurality of networks, which may include access network 6. In some examples, WAN 7 may implement Multi-Protocol Label Switching (MPLS) forwarding and in such instances may be referred to as an MPLS network or MPLS backbone. In some instances, WAN 7 represents a plurality of interconnected autonomous systems, such as the Internet, that offers services from one or more service providers. Public network 12 may represent the Internet. Public network 12 may represent an edge network coupled to WAN 7 via a transit network 22 and one or more network devices, e.g., a customer edge device such as customer edge switch or router. Public network 12 may include a data center. In the example of FIG. 1, network device 18B may exchange packets with compute nodes 10A-10D (“compute nodes 10”) of data center 9 via virtual network 20, and network device 18B may forward packets to public network 12 via transit network 22.

In examples of network system 2 that include a wireline/broadband access network, network devices 18A or 18B may represent a Broadband Network Gateway (BNG), Broadband Remote Access Server (BRAS), MPLS PE router, core router or gateway, or Cable Modem Termination System (CMTS). In examples of network system 2 that include a cellular access network as access network 6, network devices 18A or 18B may represent a mobile gateway, for example, a Gateway General Packet Radio Service (GPRS) Serving Node (GGSN), an Access Gateway (aGW), or a Packet Data Network (PDN) Gateway (PGW). In other examples, the functionality described with respect to network device 18B may be implemented in a switch, service card or another network element or component. In some examples, network device 18B may itself be a service node.

A network service provider that administers at least parts of network system 2 typically offers services to subscribers associated with devices, e.g., subscriber devices 16, that access network system 2. Services offered may include, for example, traditional Internet access, VoIP, video and multimedia services, and security services. As described above with respect to WAN 7, WAN 7 may support multiple types of access network infrastructures that connect to service provider network access gateways to provide access to the offered services, e.g., service provided by service node 10. In some instances, the network system may include subscriber devices 16 that attach to multiple different access networks 6 having varying architectures.

In general, any one or more of subscriber devices 16 may request authorization and data services by sending a session request to a gateway device such as network devices 18A or 18B. In turn, the network device may access a central server (not shown) such as an Authentication, Authorization and Accounting (AAA) server to authenticate the one of subscriber devices 16 requesting network access. Once authenticated, any of subscriber devices 16 may send subscriber data traffic toward WAN 7 to access and receive services provided by public network 12, and such packets may traverse network devices 18A or 18B as part of at least one packet flow. In some examples, network device 18A may forward all authenticated subscriber traffic to public network 12, and network device 18B may apply services and/or steer particular subscriber traffic to data center 9 if the subscriber traffic requires services on compute nodes 10. Service applications to be applied to the subscriber traffic may be hosted on compute nodes 10.

For example, network system 2 includes a data center 9 having a cluster of compute nodes 10 that provide an execution environment for the virtualized network services. In some examples, each of compute nodes 10 represents a service instance. Each of compute nodes 10 may apply one or more services to traffic flows. As such, network device 18B may steer subscriber packet flows through defined sets of services provided by compute nodes 10. That is, in some examples, each subscriber packet flow may be forwarded through a particular ordered combination of services provided by compute nodes 10, each ordered set being referred to herein as a “service chain.” As examples, compute nodes 10 may apply stateful firewall (SFW) and security services, deep packet inspection (DPI), carrier grade network address translation (CGNAT), traffic destination function (TDF) services, media (voice/video) optimization, Internet Protocol security (IPSec)/virtual private network (VPN) services, hypertext transfer protocol (HTTP) filtering, counting, accounting, charging, and/or load balancing of packet flows, or other types of services applied to network traffic.

In some examples, network system 2 comprises a software defined network (SDN) and network functions virtualization (NFV) architecture. In these examples, an SDN controller (not shown) may provide a controller for configuring and managing the routing and switching infrastructure of network system 2.

Although illustrated as part of data center 9, compute nodes 10 may be network devices coupled by one or more switches or virtual switches of WAN 7. In one example, each of compute nodes 10 may run as virtual machines (VMs) in a virtual compute environment. Moreover, the compute environment may comprise a scalable cluster of general computing devices, such as x86 processor-based services. As another example, compute nodes 10 may comprise a combination of general-purpose computing devices and special-purpose appliances. As virtualized network services, individual network services provided by compute nodes 10 can scale just as in a modern data center through the allocation of virtualized memory, processor utilization, storage and network policies, as well as horizontally by adding additional load balanced VMs. In other examples, compute nodes 10 may be gateway devices or other routers. In further examples, the functionality described with respect to each of compute nodes 10 may be implemented in a switch, service card, or another network element or component.

Subscriber devices 16 may be configured to utilize the services provided by one or more of applications 30 hosted on servers that are part of cloud-based services 26. In some aspects, cloud-based services 26 may be provided from one or more datacenters, including datacenter 9 by way of compute nodes 10. An application 30 may be configured to provide a single service, or it may be configured as multiple microservices. For purposes of illustration, it is assumed that application 30 is configured as multiple microservices. A subscriber device 16 can utilize the services of an application 30 by communicating requests to the application 30 and receiving responses from the application 30 via public network 12. In some aspects, applications 30 may be containerized applications (or microservices). Containerization is a virtualization scheme based on operating system-level virtualization. Containers are light-weight and portable execution elements for applications that are isolated from one another and from the host. Such isolated systems represent containers, such as those provided by the open-source DOCKER Container application or by CoreOS Rkt (“Rocket”). Like a virtual machine, each container is virtualized and may remain isolated from the host machine and other containers. However, unlike a virtual machine, each container may omit an individual operating system and instead provide an application suite and application-specific libraries. In general, a container is executed by the host machine as an isolated user-space instance and may share an operating system and common libraries with other containers executing on the host machine. Thus, containers may require less processing power, storage, and network resources than virtual machines. A group of one or more containers may be configured to share one or more virtual network interfaces for communicating on corresponding virtual networks.

Because containers are not tightly-coupled to the host hardware computing environment, an application can be tied to a container image and executed as a single light-weight package on any host or virtual host that supports the underlying container architecture. As such, containers address the problem of how to make software work in different computing environments. Containers offer the promise of running consistently from one computing environment to another, virtual or physical.

In the example of FIG. 1, network management system (NMS) 112 is a cloud-based computing platform that manages one or more networks of subscriber devices 16, network devices 18 of WAN 7, transit network 22, virtual network 20, etc. In general, NMS 112 may provide a cloud-based platform for wireless network data acquisition, monitoring, activity logging, reporting, predictive analytics, network anomaly identification, and alert generation. In some examples, NMS 112 outputs notifications, such as alerts, alarms, graphical indicators on dashboards, log messages, text/SMS messages, email messages, and the like, and/or recommendations regarding wireless network issues to a site or network administrator (“admin”) interacting with and/or operating user device 120. Additionally, in some examples, NMS 112 operates in response to configuration input received from the administrator interacting with and/or operating user device 120.

Cloud management system 114 is a cloud-based computing platform that provides management of cloud-based infrastructure of network system 2, such as cloud-based services 26, data center(s) 9, and/or cloud-based framework system 28. In general, cloud management system 114 may provide a cloud-based platform for wireless network data acquisition, monitoring, activity logging, reporting, predictive analytics, network anomaly identification, and alert generation. In some examples, cloud management system 114 outputs notifications, such as alerts, alarms, graphical indicators on dashboards, log messages, text/SMS messages, email messages, and the like, and/or recommendations regarding cloud-based infrastructure issues to a site or network administrator (“admin”) interacting with and/or operating user device 120. Additionally, in some examples, cloud management system 114 operates in response to configuration input received from the administrator interacting with and/or operating user device 120.

As described herein, computing devices within network system 2 may provide network monitoring services. For example, network devices 18 and/or compute nodes 10 are configured as measurement points (e.g., with APIs) to provide network monitoring services to determine, for example, network performance and functionality, as well as interconnections of service chains. APIs may be invoked to provide telemetry data (e.g., in the form of timeseries data, which may also be referred to as “time series data”) that can be used to determine health of some or all of the network. APIs may be implemented as plugin modules provided as part of a cloud as a Software-as-a-Service (SaaS) solution, software deployed on premises in NFV environments, software modules installed to host computing devices, or other implementations. Computing devices configured with APIs may send and/or receive test packets to compute one or more key performance indicators (KPIs) of the network, such as latency, delay (inter frame gap), jitter, packet loss, throughput, and the like. APIs on compute nodes may be invoked to calculate KPIs related to resource utilization, such as CPU utilization, memory utilization, etc.

In the example of FIG. 1, network device 18A is configured with Application Program Interface (“API”) 108A (“API 108A”), network device 18B is configured with API 108B, compute node 10A is configured with API 108C, compute node 10B is configured with API 108D, compute node 10C is configured with API 108E, compute node 10N is configured with API 108F, at least one application 30 of cloud-based services 26 is configured with API 108G, NMS 112 is configured with API 108H, and cloud management system 114 is configured with API 108I (collectively, “APIs 108”). Although each of network devices 18 and compute nodes 10 are described as being configured with an API, any number of network devices and/or service nodes may be configured with APIs to provide monitoring services, telemetry, configuration services, etc. APIs 108 can produce and/or collect performance data (e.g., KPIs) regarding application and network performance, provide a mechanism for configuring such applications and networks, and expose access or enable the invocation of various diagnostic, configuration, or analytic tools for the corresponding element of network system 2. In some examples, APIs 108 expose one or more tools for administration, orchestration, management, or configuration of the corresponding element of network system 2. In some examples, APIs 108 presents an interface by which to obtain configuration, state, performance, performance monitoring, telemetry, or other data that describes the operation of a system of network system 2. Each API may employ a different API schema. For example, each API may be accessed using different parameters and may receive inputs, store data, and generate outputs according to different formats.

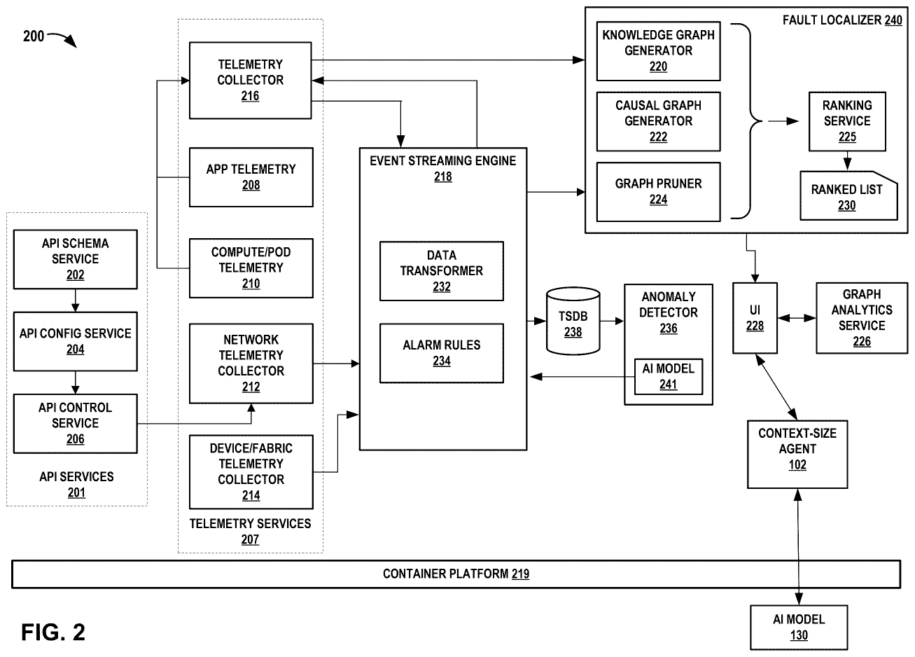

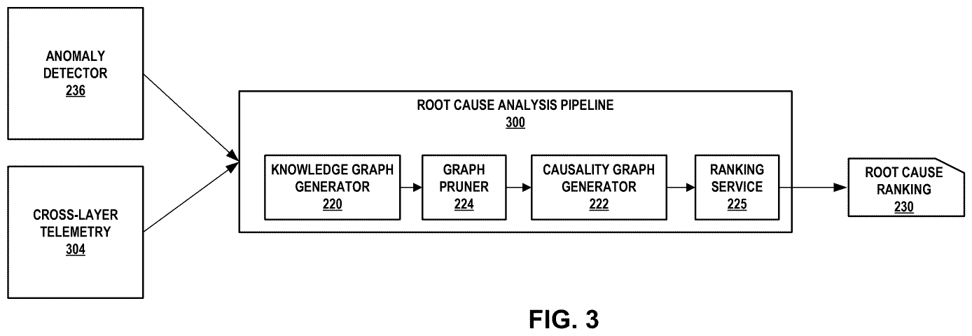

APIs 108 and other devices and services send their KPIs 24 to cloud-based analysis framework system 28 as a time series data. Cloud-based analysis framework system 28 can receive KPIs and other data from APIs 108, and use the received data to detect anomalies in network and/or compute node operation. In some aspects, cloud-based analysis framework system 28 can be implemented, at least in part, as a containerized framework system. Further details on the processing of the time series of data are provided below with respect to FIGS. 2 and 3.

Additional information regarding cloud-based analysis framework system 28 may be found within U.S. Patent App. Pub. No. 2024/0007342, entitled “FRAMEWORK FOR AUTOMATED APPLICATION-TO-NETWORK ROOT CAUSE ANALYSIS,” which was filed on Jun. 30, 2023 and published on Jan. 4, 2024, the entire content of which is incorporated by reference herein.

AI model 130 may be, e.g., a conversational assistant with which a user may provide a natural language query (also referred to as a “prompt”) and receive a natural language response. AI model 130 may be hosted by a third-party computing system, such as a cloud computing system, or may be hosted on premises, in a data center, and other type of deployment. During a training phase, an operator, such as an engineer or developer, trains AI model 130 with large datasets of training data, such as documents and text, to provide a contextually-relevant answer to user queries. In some examples, AI model 130 is a language model such as a large language model (LLM) or a small language model (SLM), a Long Short-term Memory (LSTM) model, a deep learning model, or any other model that uses generative AI or machine learning techniques.

In some examples, AI model 130 provides tool invocation capabilities. For example, AI model 130 may interact with external software and APIs, such as APIs 108. In this process, AI model 130 determines, based on a prompt from user device 120, whether the generation of a response may request additional information or actions beyond its internal data. If so, AI model 130 may execute software functions, such as invoking API functions of APIs 108 (as described in more detail below) to obtain resulting output for use in generating the response. AI model 130 may draw from this resulting output to generate the response to the prompt obtained from user device 120. The use of tool invocation may enable AI model 130 to provide, in real time, specific, accurate information about detailed infrastructure upon which AI model 130 was not originally trained, such as the complex network topology of network system 2. For example, AI model 130 may invoke an API 108 to obtain health, performance, and telemetry data for one or more network devices within network system 2. AI model 130 may use the resultant output as part of generating a response to a query regarding a health, a performance, or an operational status regarding network system 2 (or a component thereof).

Conventionally, AI models may be unable to ingest the output of API invocation due to the large quantities of data generated by such API invocation and context-size limit restrictions of such AI models. For example, some AI models may have a context-size limit of, e.g., less than 3000 characters. Invoking an API to obtain health, performance, and telemetry data about, e.g., one or more network devices may produce a voluminous amount of data (e.g., tens of thousands of characters) that may exceed the context-size limit of the AI model, preventing the use of such output data by the AI model.

As another example, even where an AI model has a context-size limit in the millions of characters and so is practically not context-size restricted, the majority of data in an API invocation may be largely irrelevant to the original user query. The inclusion of a large amount of irrelevant data may reduce the accuracy of the response of the AI model and may increase the likelihood of inaccurate, hallucinatory, or off-topic responses.

In accordance with the techniques of the disclosure, system 2 includes context-size agent 102, which may operate with AI model 130, for analysis of data obtained from invoking APIs 108 (also referred to herein as “API data”), even where such data exceeds a context limit or input limit of AI model 130. As described in more detail below, context-size agent 102 may leverage AI model 130 itself to parse or filter the API data obtained from invoking APIs 108, so as to craft a prompt that subsequently may be provided to the same AI model 130. In this fashion, context-size agent 102 may use AI model 130 to generate a prompt that both satisfies the context-size limit of AI model 130, includes focused, relevant information obtained from invoking APIs 108 useful for answering a user's query, and excludes irrelevant data within API data from the prompt, so as to increase the accuracy of the response generated by AI model 130.

Context-size agent 102 receives natural language query 104 from user device 120. In some optional examples, context-size agent 102 provides an input specifying natural language query 104 and a description of the plurality of APIs 108 to AI model 130 to obtain, from AI model 130, a selection of one or more APIs 108 of the plurality of APIs 108 that may include information relevant to answering natural language query 104 and one or more parameters for invoking the selected one or more APIs 108. In other optional examples, context-size agent 102 receives a selection of the one or more APIs 108 and the one or more parameters from a user, such as an administrator of the computing system, via user device 120. Context-size agent 102 invokes the selected one or more APIs 108 with the one or more parameters to obtain raw data from the selected one or more APIs 108. Typically, the raw data exceeds a context size of AI model 130.

In some optional examples, context-size agent 102 provides an input specifying the natural language query and one or more schemas for the selected one or more APIs 108 to AI model 130 to obtain, from AI model 130, parsing criteria. In other optional examples, context-size agent 102 receives the parsing criteria from a user, such as an administrator for the selected one or more APIs 108, via user device 120. The parsing criteria comprises criteria for reducing a size of the raw data. In some examples, the parsing criteria comprises criteria for excluding certain portions of the raw data to achieve a data set of a smaller size that satisfies the context-size limit of AI model 130. For example, the parsing criteria may comprise filtering criteria for filtering the raw data into filtered data, so as to eliminate or exclude data not matching the filtering criteria. Context-size agent 102 applies the parsing criteria to the raw data obtained from the one or more APIs 108 to produce parsed data. The parsed data (or, e.g., filtered data) is equal to or less than the context size of AI model 130.

Context-size agent 102 provides an input specifying the natural language query and the parsed data to AI model 130 to obtain, from AI model 130, a natural language answer to the natural language query. For example, the natural language answer may provide troubleshooting information about the plurality of APIs 108, applications 30, or network system 2. In other examples, the natural language answer may assist in root cause identification of a failure within network system 2 employing the plurality of APIs 108 or applications 30. In other examples, the natural language answer may provide health or status information for the plurality of APIs 108, applications 30, or network system 2. Context-size agent 102 outputs, to an output device, the natural language answer. For example, context-size agent outputs, to user device 120, the natural language answer for display to a user, such as an administrator.

In the example of FIG. 1, context-size agent 102 and APIs 108 are described as part of network system 2. However, it should be understood that this is provided as an example only, and the techniques of the disclosure may be applicable to any system that uses API tool invocation, beyond the example of cloud-based analytics for cloud-based services described here.

FIG. 2 is a block diagram illustrating system 200 in accordance with one or more aspects of the disclosure. System 200 can be implemented as part of cloud-based analysis framework system 28 (FIG. 1). In some aspects, system 200 includes API services 201, telemetry services 207, telemetry collector 216, event streaming engine 218, and fault localizer 240.

API services 201 include services that create, configure, invoke, and/or control APIs that collect KPIs or network telemetry data (e.g., APIs 108 of FIG. 1). In some aspects, API services 201 can include API schema service 202, API configuration service 204 and API control service 206. API schema service 202 analyzes a configuration, such as a network configuration, and can determine an API schema adapted for APIs of particular devices or types of devices (both physical and virtual) that may be present in network system 2.

API configuration service 204 can configure APIs based at least in part on a schema determined by API schema service 202. API control service 206 can invoke APIs and monitor the invocation of API (e.g., APIs 108).

API schema service 202 is responsible for determining a set of APIs that need to be configured for a given device, which is determined based on the topology and corresponding application placement in network system 2. API schema service 202 can receive a network topology and an application location as an input, and can determine one or more schemas that can be used to interface with an API of a corresponding application.

Depending on the environment, schemas for different types of APIs may need to be used. For example, different applications may generate and store data in different formats, and APIs corresponding to those applications may accept parameters or invocations in different manners. Moreover, there are different types of topologies, e.g., underlay network, overlay network, Kubernetes Clusters, etc., for which APIs may need to be accessed. Depending on the topology, different schemas may be supported while considering application needs, coverage, and cost for a given topology.

Telemetry services 207 includes services that collect telemetry from APIs across multiple layers of networked system such as system 2 of FIG. 1. As used herein, a layer can refer to a set of components (real or virtual) that use resources and services provided by another set of components at a different layer. In cases where a first component uses resources or services of a second component, the first component can be said to be dependent on the second component. For example, applications at an application layer may use resources and services of a compute node at a compute node layer. The compute node layer may, in turn, use resources and services provided by network devices at a network layer, and so on. Thus, applications at the application layer are dependent on compute nodes at a compute node layer, which in turn, may be dependent on physical network devices at the physical layer.

In some aspects, telemetry services 207 include telemetry collector 216, network telemetry collector 212, and device/fabric telemetry collector 214. Telemetry collector 216 can collect application telemetry 208 such as application performance data. Application telemetry may be collected using service-mesh, Istio, etc. Telemetry collector 216 can also collect compute/pod telemetry 210. Compute/pod telemetry 210 can include Kubernetes pod and node performance telemetry data such as central processor unit (CPU) usage, memory usage, network statistics, etc. In some aspects, network telemetry collector 212 can be implemented using the Prometheus monitoring system combined with the Thanos high availability and data storage systems. Both Prometheus and Thanos are open source components.

Network telemetry collector 212 can collect telemetry data that measure end-to-end network performance. For example, network telemetry collector 212 can collect network performance measurements obtained or created by APIs 108. Device/fabric telemetry collector 214 can collect telemetry data from network devices in a network fabric of network system 2 (e.g., network devices 18).

Event streaming engine 218 can receive telemetry data collected by telemetry services 207 such as telemetry collector 216, network telemetry collector 212, device telemetry collector 214 and others, and can store the data as time series data in time series database (TSDB) 238. The data received from telemetry services 207 may be in different formats depending on the source of the telemetry data and the collector used to collect the telemetry data. In some aspects, data transformer 232 apply data transforms to input data to normalize the data and/or to put the data into a standardized format. In some aspects, the data is transformed to an openTSDB format. In some aspects, event streaming engine 218 may be implemented, at least in part, using the Kafka stream processing system.

Event streaming engine may apply alarm rules 234 to the incoming telemetry data. Alarm rules 234 can be a set of one or more rules that indicate telemetry values that are anomalous, e.g., outside of desired ranges, over or under limits, etc.

Anomaly detector 236 can apply AI model 241 to time series of telemetry data from TSDB 238 to determine anomalous conditions related to the time series of telemetry data. In some aspects, AI model 241 can be trained using supervised or unsupervised learning techniques to discover relationships between KPIs in telemetry data and anomalous conditions within one or more layers of a multi-layered network system such as system 2 of FIG. 1. These relationships can be across multiple layers of the network model. For example, KPIs that are associated with a network device can be related to KPIs of an application that utilizes the network device to communicate with another service. As an example, KPIs that indicate a bottleneck at a network device or CPU overload on a host device can affect response time KPIs of an application that runs on the host and/or utilizes the network device for communication with another endpoint in the network.

Telemetry services 207 includes services that collect telemetry from APIs across multiple layers of networked system such as system 2 of FIG. 1. As used herein, a layer can refer to a set of components (real or virtual) that use resources and services provided by another set of components at a different layer. In cases where a first component uses resources or services of a second component, the first component can be said to be dependent on the second component. For example, applications at an application layer may use resources and services of a compute node at a compute node layer. The compute node layer may, in turn, use resources and services provided by network devices at a network layer, and so on. Thus, applications at the application layer are dependent on compute nodes at a compute node layer, which in turn, may be dependent on physical network devices (e.g., compute nodes 10 shown in the example of FIG. 1) at the network physical layer.

In some aspects, telemetry services 207 include telemetry collector 216, network telemetry collector 212, and device/fabric telemetry collector 214. Telemetry collector 216 can collect application telemetry 208 such as application performance data. Application telemetry may be collected using service-mesh, Istio, etc. Telemetry collector 216 can also collect compute/pod telemetry 210. Compute/pod telemetry 210 can include Kubernetes pod and node performance telemetry data such as central processor unit (CPU) usage, memory usage, network statistics, etc. In some aspects, network telemetry collector 212 can be implemented using the Prometheus monitoring system combined with the Thanos high availability and data storage systems. Both Prometheus and Thanos are open source components.

Network telemetry collector 212 can collect telemetry data that measure end-to-end network performance. For example, network telemetry collector 212 can collect network performance measurements obtained or created by APIs 108.

Device/fabric telemetry collector 214 can collect telemetry data from network devices in a network fabric of network system 2 (e.g., network devices 18).

Event streaming engine 218 can receive telemetry data collected by telemetry services 207 such as telemetry collector 216, network telemetry collector 212, device telemetry collector 214 and others, and can store the data as time series data in time series database (TSDB) 238. The data received from telemetry services 207 may be in different formats depending on the source of the telemetry data and the collector used to collect the telemetry data. In some aspects, data transformer 232 apply data transforms to input data to normalize the data and/or to put the data into a standardized format. In some aspects, the data is transformed to an openTSDB format. In some aspects, event streaming engine 218 may be implemented, at least in part, using the Kafka stream processing system.

Event streaming engine may apply alarm rules 234 to the incoming telemetry data. Alarm rules 234 may represent a set of one or more rules that indicate telemetry values that are anomalous, e.g., outside of desired ranges, over or under limits, etc.

Anomaly detector 236 can apply AI model 241 to time series of telemetry data from TSDB 238 to determine anomalous conditions related to the time series of telemetry data. In some aspects, AI model 241 can be trained using supervised or unsupervised learning techniques to discover relationships between KPIs in telemetry data and anomalous conditions within one or more layers of a multi-layered network system such as system 2 of FIG. 1. These relationships can be across multiple layers of the network model. For example, KPIs that are associated with a network device can be related to KPIs of an application that utilizes the network device to communicate with another service. As an example, KPIs that indicate a bottleneck at a network device or CPU overload on a host device can affect response time KPIs of an application that runs on the host and/or utilizes the network device for communication with another endpoint in the network.

Anomaly detector 236 may invoke fault localizer 240 when a fault (e.g., an anomalous condition) is detected using alarm rules or detected using AI model 241. In some aspects, fault localizer 240 includes knowledge graph generator 220, causal graph generator 222, graph pruner 224 and ranking service 225. In some aspects, knowledge graph generator 220, causal graph generator 222, graph pruner 224, and ranking service 225 may be executed as part of a root cause analysis pipeline, an example of which is shown in FIG. 3.

Knowledge graph generator 220 can generate, based on data in TSDB 238 and relationships discovered in AI model 241, dependencies between different application and infrastructure entities of network system 2. Causal graph generator 222 generates further graph data on top of a knowledge graph generated by knowledge graph generator 220 to form a causal graph. The causal graph captures causal relationships between different performance KPIs and anomalous conditions. Graph pruner 224 prunes the knowledge graph and causal graph to determine a subset of the graphs to be used in root cause localization. Ranking service 225 ranks the nodes in the causal graph to generate root cause ranked list 230 and to indicate the nodes that are likely to be the root cause of an observed anomaly in the order of likelihood that the node caused the anomaly.

System 200 may further include graph analytics service 226 and user interface (UI) 228. Graph analytics service 226 can receive graph queries on the knowledge and causality graph for further investigation and validation of fault localization results. In some aspects, graph analytics service 226 can be used to perform alarm propagation path analysis, graph change analysis, fault injection analysis, or application-to-network mapping analysis. UI 228 may present information related to the fault localization results and analysis by graph analytics service 226.

In some examples, one or more APIs 108 store raw data that indicates a state of a computer network, such a state of one or more of network system 2, cloud-based services 26, cloud-based analysis framework 28, data center 9, WAN 7, access network 6, RAN 4, or an enterprise network that includes subscriber devices 16 of FIG. 1. For example, the raw data may include network telemetry data (such as application layer telemetry data, compute/pod layer telemetry data, network layer telemetry data, device layer telemetry data, fabric layer telemetry data, etc.), performance data (such as network or network device performance metrics data), health data, user feedback data, network management data or orchestration data for managing network system 2, network configuration data (such as network device configuration data or configuration information for network system 2), network anomaly data, etc. Such data may be generated or obtained by various elements of network system 2, such as subscriber devices 16, CE devices 11, network devices 11, compute nodes 10, of FIG. 1 etc., and collected by any of telemetry collector 216, network telemetry collector 212 and/or device/fabric telemetry collector 214. Other applications may invoke APIs 108 to access such raw data.

In accordance with the techniques of the disclosure, system 200 further includes context-size agent 102 and APIs 108, which may operate in a substantially similar fashion as the like elements of FIG. 1. For example, context-size agent 102 receives natural language query 104 from user device 120 via UI 228. In some optional examples, context-size agent 102 provides an input specifying natural language query 104 and a description of the plurality of APIs 108 to AI model 130 to obtain, from AI model 130, a selection of one or more APIs 108 of the plurality of APIs 108 that may include information relevant to answering natural language query 104 and one or more parameters for invoking the selected one or more APIs 108. Typically, AI model 130 may be provided as a service by a third party managed separately from container platform 219 and its components. In other optional examples, context-size agent 102 receives a selection of the one or more APIs 108 and the one or more parameters from a user, such as an administrator of the computing system, via user device 120. Context-size agent 102 invokes the selected one or more APIs 108 with the one or more parameters to obtain the raw data from the selected one or more APIs 108. Typically, the raw data exceeds a context size of AI model 130.

In some optional examples, context-size agent 102 provides an input specifying documentation, such as documents, technical specifications, designs, or code for the selected APIs 108 to AI model 130 to obtain, from AI model 130, one or more schemas for the one or more APIs 108. In other optional examples, context-size agent 102 receives the one or more schemas from a user, such as an administrator for the selected one or more APIs 108, via user device 120.

Context-size agent 102 provides an input specifying the natural language query and the one or more schemas for the selected one or more APIs 108 to AI model 130 to obtain, from AI model 130, parsing criteria. In other optional examples, context-size agent 102 receives the parsing criteria from a user, such as an administrator for the selected one or more APIs 108, via user device 120. The parsing criteria comprises criteria for reducing a size of the raw data. In some examples, the parsing criteria comprises criteria for excluding certain portions of the raw data to achieve a data set of a smaller size that satisfies the context-size limit of AI model 130. Context-size agent 102 applies the parsing criteria to the raw data obtained from the one or more APIs 108 to produce parsed data. The parsed data (or, e.g., filtered data) is equal to or less than the context size of AI model 130.

In some examples, the parsing criteria comprises filtering criteria for filtering the raw data into filtered data, so as to eliminate or exclude data not matching the filtering criteria. In some examples, the filtering criteria comprises one or more JavaScript Object Notation (JSON) path query expressions. For example, context-size agent 102 generates, based on the raw data obtained from the selected one or more APIs 108, one or more JSON documents. Context-size agent 102 applies the one or more JSON path query expressions to the one or more JSON documents to obtain the filtered data.

In some examples, the filtering criteria comprises one or more Xpath query expressions. For example, context-size agent 102 generates, based on the raw data obtained from the selected one or more APIs 108, one or more Extensible Markup Language (XML) documents. Context-size agent 102 applies the one or more Xpath query expressions to the one or more XML documents to obtain the filtered data. The use of Xpath and XML may provide increased accuracy over the use of JSON path query expressions where AI model 130 is trained upon multiple versions or variations of JSON and/or JSON path queries or where the use of JSON.

As an example, the raw data obtained from the selected one or more APIs 108 comprises one or more of network telemetry data, network performance data, network management data, network configuration data, or network anomaly data for network system 2. Such data may include voluminous, detailed information about a plurality of devices and components of network system 2. Context-size agent 102 applies the parsing criteria to the raw data to obtain a set of parsed data. For example, the parsing criteria may specify a path expression for parsing the raw data to identify portions of the raw data that describe network devices, their corresponding network device interfaces, and a name of each network device interface.

As an example, the raw data comprises one or more of network telemetry data, network performance data, network management data, network configuration data, or network anomaly data of network system 2. Context-size agent 102 applies the parsing criteria to the raw data to obtain parsed data that includes portions of the raw data and excludes other portions of the raw data. For example, the parsed data includes portions of the raw data associated with a network device 18A of a plurality of network devices 18 (e.g., such as portions of the raw data comprising network telemetry data, network performance data, network management data, network configuration data, or network anomaly data associated with network device 18A) and excludes portions of the raw data associated with others of the plurality of network devices (e.g., such as portions of the raw data comprising network telemetry data, network performance data, network management data, network configuration data, or network anomaly data associated with network device 18B). As another example, the parsed data includes portions of the raw data associated with a network interface of a plurality of network interfaces (e.g., such as portions of the raw data comprising network telemetry data, network performance data, network management data, network configuration data, or network anomaly data associated with a first network interface of network device 18A) and excludes portions of the raw data associated with others of the plurality of network interfaces (e.g., such as portions of the raw data comprising network telemetry data, network performance data, network management data, network configuration data, or network anomaly data associated with a second network interface of network device 18A).

Context-size agent 102 may apply various path expressions to, for example, identify portions of data that describe network devices, network interfaces, performance metrics such as latency, jitter, bandwidth, packet loss, etc., link and path names, routing tables, network address information for various network devices, clients or customers to whom various network devices are assigned, applications to which network traffic belongs, parameters with which network devices are configured, certain types of network anomalies or events, etc.

In addition, context-size agent 102 may apply path expressions to, for example, obtain filtered subsets of the raw data that are of a smaller size. For example, the parsing criteria (or filtering criteria) may specify a path expression for parsing or filtering the raw data to obtain data associated with a subset of network devices, such as network devices of a particular make and model, network devices exchanging network traffic for a particular client or application, network devices within a particular geological region, etc. For example, the parsing criteria may specify a path expression for parsing or filtering the raw data to identify portions of the raw data that describe network anomalies associated with compute node 10A of FIG. 1; portions of the raw data that describe network performance data and telemetry data associated with each of network devices 18 of FIG. 1, or configuration data associated with WAN 7.

Context-size agent 102 provides an input specifying the natural language query and the parsed data to AI model 130 to obtain, from AI model 130, a natural language answer to the natural language query. For example, the natural language answer may provide troubleshooting information about the plurality of APIs 108, applications 30, or network system 2. In other examples, the natural language answer may assist in root cause identification of a failure within network system 2 employing the plurality of APIs 108 or applications 30. In other examples, the natural language answer may provide health or status information for the plurality of APIs 108, applications 30, or network system 2. Context-size agent 102 outputs, to an output device, the natural language answer. For example, context-size agent outputs, to user device 120, the natural language answer for display to a user, such as an administrator.

As an example of the above, consider a query 104 received from user device 120 asking “Are any network devices causing network performance issues within network system 2”? Context-size agent 102 provides an input specifying query 104 and a description of the plurality of APIs 108 to AI model 130 to obtain, from AI model 130, a selection of one or more APIs 108 of the plurality of APIs 108 that may include information relevant to answering natural language query 104 and one or more parameters for invoking the selected one or more APIs 108. The selection from AI model 130 identifies, e.g., APIs 108A and 108B, which store configuration data, network telemetry data, and network performance data for network devices 18A and 18B, respectively, as well as one or more parameters for invoking APIs 108A and 108B to obtain raw data describing network devices 18A and 18B.

Context-size agent 102 invokes APIs 108A and 108B with the one or more parameters to obtain the raw data comprising configuration data, network telemetry data, and network performance data for network devices 18A and 18B. This raw data may be of a large quantity, and may include large volumes of irrelevant information. For example the raw data may include configuration data, network telemetry data, and network performance data for devices other than network devices 18A and 18B, or may include historical data indicative of routine behavior (and not indicative of anomalous events associated with network devices 18A and 18B).

Context-size agent 102 further provides an input specifying the natural language query and the one or more schemas for the selected APIs 108A and 108B to AI model 130 to obtain, from AI model 130, parsing criteria for application to the raw data. In this example, the parsing criteria comprises one or more path expressions for parsing the raw data to obtain parsed data comprising data describing anomalies associated with network devices 18A and 18B, as well as telemetry, performance, and configuration data for network devices 18A and 18B that is contemporaneous with the anomalies.

Context-size agent 102 provides an input specifying the natural language query and the parsed data to AI model 130 to obtain, from AI model 130, a natural language answer to the natural language query. For example, the natural language answer may indicate that an interface of network device 18A appears to be misconfigured, and is causing a network anomaly as indicated by poor performance characteristics (e.g., high packet loss) exhibited in the parsed data.

In some examples where the raw data obtained from APIs 108 indicates a state of a computer network, the computer network may be configured based on the natural language answer obtained from AI model 130. For example, an administrator, or context-size agent 102 (or another component of cloud-based analysis framework system 28 of FIG. 1) may use the natural language answer to generate network configuration data to configure network system 2 based on the natural language answer.

For example, the raw data obtained from APIs 108 may include network telemetry and performance data for, e.g., network devices 18 of FIG. 1. The natural language answer may indicate an issue, such as a failure or misconfiguration with a particular network element, such as network device 18A. In some examples, an administrator may use the natural language answer to perform failure diagnosis and root-cause analysis of the issue with network device 18A and reconfigure network system 2 to remediate such issue. For example, the administrator may perform a routing change, adjust a configuration of a network service, replace a network device or component, reboot or restart the network device or component, install updated software or firmware, or adjust a routing table, link, or path used by network device 18A (or another network device 18) to forward network traffic, etc.

In another example, instead of an administrator generate network configuration data to configure network system 2 based on the natural language answer, cloud-based analysis framework system 28 may implement a network management application which may process the natural language answer to perform failure diagnosis and root-cause analysis of an issue with network system 2 and generate configuration data to configure network system 2 to remediate such issue. For example, the network management application may use the natural language answer to identify an issue with a particular component (such as network device 18A), and reconfigure network system 2 to remediate such issue. In some examples, the network management application may use the natural language answer to autonomously perform a routing change, adjust a configuration of a network service, reboot or restart a network device or component, install updated software or firmware, or adjust a routing table, link, or path used by network device 18A (or another network device 18) to forward network traffic, etc.

FIG. 3 shows a root cause analysis pipeline, in accordance with one or more aspects of the disclosure. In some aspects, root cause analysis pipeline 300 includes knowledge graph generator 220, causal graph generator 222, graph pruner 224 and ranking service 225, each of which is described above with respect to the example of FIG. 2. Cross-layer telemetry is collected across multiple layers of the infrastructure from application to network (e.g., cloud-based analysis framework system 28 of FIG. 1) in the form of timeseries data. This telemetry includes performance metrics for different layers which reflects a health of the different components of the cloud-based analysis framework system 28. The telemetry can be collected and analyzed in real-time to automatically detect and troubleshoot anomalies and provide root causes of anomalies in a cloud-based analysis framework system 28.

Processing by root cause analysis pipeline 300 can be initiated when a performance anomaly is detected for a given application. For example, anomaly detector 236 may identify, using AI model 241, anomalies and supply information regarding the anomalies to root cause analysis pipeline 300 using cross-layer telemetry 304. As an example, cross-layer telemetry 304 can include application layer telemetry data, compute/pod layer telemetry data, network layer telemetry data, device layer telemetry data, fabric layer telemetry data etc. collected by any of telemetry collector 216, network telemetry collector 212 and/or device/fabric telemetry collector 214. Additionally, or instead, anomalies may be detected using rule-based anomaly detection and provided to root cause analysis pipeline 300.

As another example, root cause analysis pipeline 300 can be initiated upon request by a user, such as an administrator, responsive to natural language response 106 specifying a health of cloud-based analysis framework system 28 described in FIGS. 1-2 above. In addition, root cause analysis pipeline 300 can be initiated upon detection of one or more anomalies may be detected as a result of a monitoring task specified by a user via natural language query 104 described in FIGS. 1-2 above.

After an application performance issue is detected, knowledge graph generator 220 initiates creation of a knowledge graph from the real-time telemetry collected during the time period when the application anomaly is detected. As an example, if an application anomaly is detected at time T, then knowledge graph generator 220 can generate a knowledge graph for the entire infrastructure from application to network using cross-layer telemetry 304 for the past N time periods. Where N can be 5 minutes, 15 minutes, 30 minutes, etc.

Telemetry for each layer is parsed to determine the nodes for each layer and their relationships with the neighboring nodes. Generally speaking, a node can represent any entity in a network system, whether physical, virtual, or software. As an example, a node may represent a device such as a network device, a computing device, a virtual device (e.g., virtual machine, virtual router, virtual routing and forwarding (VRF) etc.), an application, a service, a microservice etc. For example, from the response time telemetry for micro services, caller and callee services can be identified from the labels that are present in the telemetry. Similarly, if an application is hosted on Kubernetes platform, then relationships between a microservice and its multiple instances can be determined from the pod level telemetry.

A knowledge graph generated by knowledge graph generator 220 can include multiple layers such as an Application layer, Pod Instance layer, Compute Node layer, Network Probe layer, and/or Network Fabric Layers. Depending on the environment, other layers in the knowledge graph can be defined and added. For an example, a root cause analysis framework system can be used to model the different components within a router/switch, where dependency of the ingress ports, ingress queues, fabric ports, egress ports, egress queues can be represented as a knowledge graph. System 200 can be extended to such environments.

Graph pruner 224 can prune a knowledge graph to a smaller set of nodes based on the anomalies. In some aspects, pruning is done so that only nodes within a threshold distance of a node exhibiting an anomaly are selected. As used herein, a distance between two nodes is the number of edges between the nodes in the graph. In some aspects, the threshold distance is one (1), resulting in selection of the node experiencing the anomaly and its immediate neighbors. Pruning the graph can result in a smaller graph over which further root cause analysis is performed.

Knowledge graph generator 220 can expose APIs for creation and processing of the knowledge graph. Causality graph generator 222 can create a causality graph based on the pruned knowledge graph. Each node in the pruned knowledge graph has set of distinct KPIs. Causality graph generator 222 can use the KPI to add nodes to the nodes of the pruned knowledge graph. The causality graph can be generated in various ways.

After causality graph generator 222 has generated a causality graph, ranking service 225 can analyze the graph and rank the most likely root causes of an anomaly. In some aspects, ranking service 225 uses a “PageRank” algorithm to rank the nodes in the causality graph. In the PageRank algorithm, the importance of webpage increases if other important webpages point to the given page. A similar analogy is used to rank the nodes in the causality graph, where node is likely to get higher score if it is being pointed by other nodes to be the root cause.

There are two modes in which a PageRank algorithm is used. In the first mode, a root cause can be determined for all service level anomalies observed in the causality graph. In the second mode, a personalized PageRank algorithm can be used that is focused on performing root cause analysis on a selected set of services or infrastructure components.

The techniques of FIG. 3 are described for root cause analysis of distributed microservice-based applications deployed in a data center network. However, the techniques of the disclosure may be adapted to other environments.

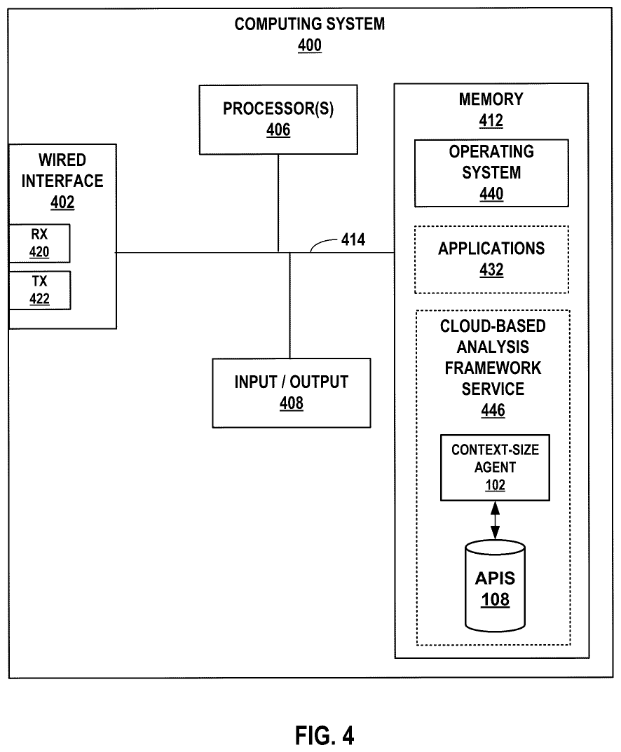

FIG. 4 is a block diagram illustrating an example computing system 400, in accordance with techniques described in this disclosure. Computing system 400 of FIG. 4 may represent any of network devices 18, server hosting service nodes 10, servers or other computing devices associated with applications 30 of FIG. 1, or servers or computing devices associated with context-size agent 102 of FIGS. 1 and 2.

In this example, computing system 400 includes a communications interface 402, e.g., an Ethernet interface, a processor 406, input/output 408, e.g., display, buttons, keyboard, keypad, touch screen, mouse, etc., a memory 412 coupled together via a bus 414 over which the various elements may interchange data and information. Communications interface 402 couples the computing system 400 to a network, such as an enterprise network. Though only one interface is shown by way of example, those skilled in the art should recognize that network nodes may, and usually do, have multiple communication interfaces. Communications interface 402 includes a receiver (RX) 420 via which computing system 400, e.g., a server, can receive data and information. Communications interface 402 includes a transmitter (TX) 422, via which computing system 400, e.g., a server, can send data and information.

Memory 412 stores executable operating system 440 and may, in various configurations, store instructions for software applications 432 and/or cloud-based analysis framework service 446. For example, computing system 400 may be configured as a server that is part of cloud-based analysis framework system 28 of FIG. 1. In such configurations, application 432 may be an implementation of one or more of applications 30 of FIG. 1.

Computing system 400 may be configured as a server that is part of cloud-based analysis framework system 28. In such configurations, memory 412 may store one or more cloud-based analysis framework services 446 that communicate with or exchange data with cloud-based analysis framework system 28 of FIG. 1. Cloud-based analysis framework service 446 may be or include any combination of API services 201, telemetry services 207, event streaming engine 218, fault localizer 240, graph analytics service 226, or anomaly detector 236 of FIG. 2.

Computing system 400 implements context-size agent 102 and APIs 108 as software or a combination of software and hardware. Context-size agent 102 and APIs 108 may be or include any combination of context-size agent 102 and APIs 108 of FIGS. 1-2.

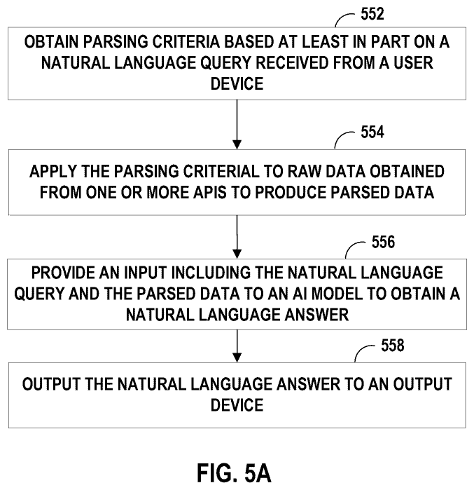

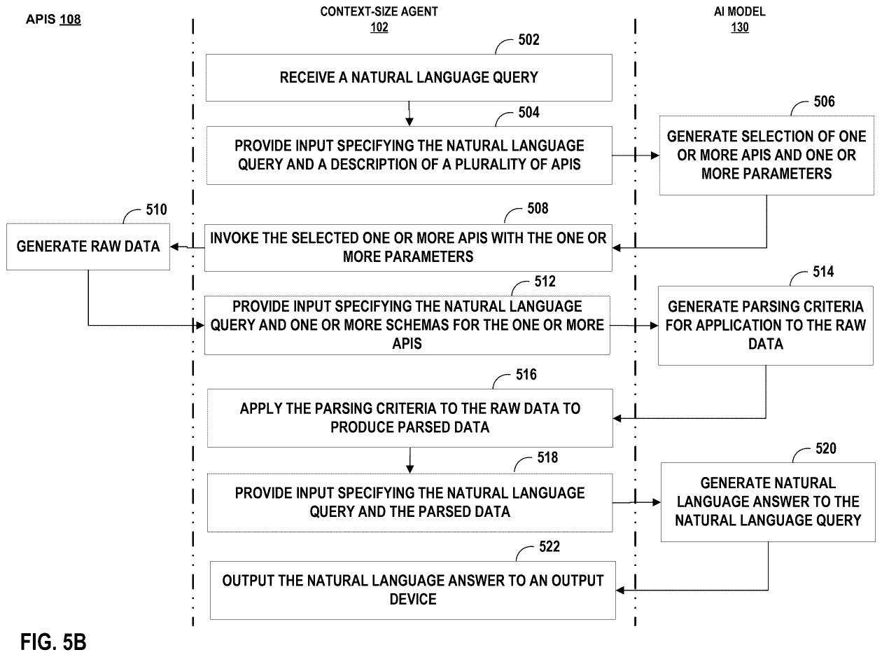

FIG. 5A is a flowchart illustrating an example operation in accordance with techniques described in this disclosure. FIG. 5A is described with respect to FIG. 1 but illustrates an example operation that may be performed by other examples in accordance with this disclosure.

Context-size agent 102 obtains parsing criteria based at least in part on a natural language query received from user device 120 (552). In some examples, Context-size agent 102 obtains the parsing criteria from AI model 130 based at least in part on an input specifying the natural language query. Context-size agent 102 applies the parsing criteria to raw data obtained from one or more APIs 108 to produce parsed data (554). In some examples, the parsing criteria comprises criteria for excluding certain portions of raw data to achieve a data set of a smaller size. For example, the parsing criteria may comprise filtering criteria for filtering the raw data to eliminate or exclude data not matching the filtering criteria. The parsed data is equal to or less than the context size of AI model 130.

Context-size agent 102 provides, to AI model 130, an input including the natural language query and the parsed data (556) to obtain, from AI model 130, a natural language answer to the natural language query. Context-size agent 102 outputs, to user device 120, the natural language answer to an output device for display to a user (558).

FIG. 5B is a flowchart illustrating an example operation in accordance with techniques described in this disclosure. FIG. 5B is described with respect to FIG. 1 but illustrates an example operation that may be performed by other examples in accordance with this disclosure.

Context-size agent 102 receives natural language query 104 from user device 120 (502). Context-size agent 102 provides an input specifying natural language query 104 and a description of the plurality of APIs 108 to AI model 130 (504). AI model 130 generates, from the input, a selection of one or more APIs 108 of the plurality of APIs 108 including information relevant to answering natural language query 104 and one or more parameters for invoking the selected one or more APIs 108 (506).

Context-size agent 102 invokes the selected one or more APIs 108 with the one or more parameters (508). In response, APIs 108 generate raw data (510). Typically, the raw data exceeds a context size of AI model 130. Context-size agent 102 obtains, from APIs 108, the raw data.

Context-size agent 102 provides an input specifying the natural language query and one or more schemas for the selected one or more APIs 108 to AI model 130 (512). AI model 130 generates, from the input, parsing criteria for application to the raw data to reduce a size of the raw data (514). In some examples, the parsing criteria comprises criteria for excluding certain portions of the raw data to achieve a data set of a smaller size. For example, the parsing criteria may comprise filtering criteria for filtering the raw data to eliminate or exclude data not matching the filtering criteria.

Context-size agent 102 obtains, from AI model 130, the parsing criteria. Context-size agent 102 applies the parsing criteria to the raw data obtained from the one or more APIs 108 to produce parsed data (516). The parsed data is equal to or less than the context size of AI model 130.

Context-size agent 102 provides an input specifying the natural language query and the parsed data to AI model 130 (518). AI model 130 processes the input to generate a natural language answer to the natural language query (520). Context-size agent 102 obtains, from AI model 130, the natural language answer to the natural language query. Context-size agent 102 outputs, to user device 120, the natural language answer to an output device for display to a user (522).

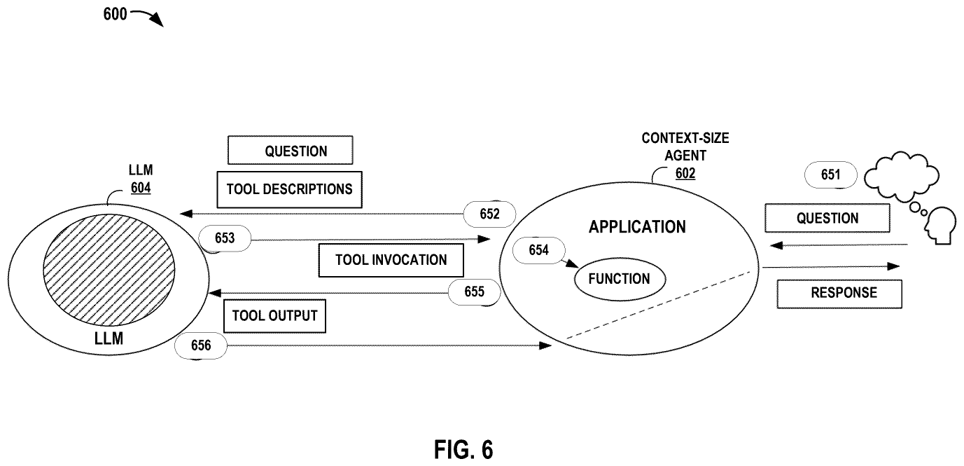

FIG. 6 is a block diagram illustrating an example system 600 for performing function calling in accordance with the techniques described in this disclosure. System 600 includes context-size agent 602 and LLM 604. Context-size agent 602 may be an example of context-size agent 102 of FIG. 1. LLM 604 may be an example of AI model 130 of FIG. 1.

Function calling is a technique that allows LLM 604 to interact with external systems to collect data and perform tasks. Passing data from external systems as context in LLM API calls allows LLM 604 to respond to questions based on information it was not originally trained on. As depicted in FIG. 6, this technique involves passing LLM 604 a set of descriptions of available tools 652, along with a natural language question 651 to be answered. As part of its reasoning logic, if LLM 604 determines external information is required to answer a question, LLM 604 responds with a set of tools to be invoked 653, along with any input parameters needed for context-size agent 602 to make associated function calls 654. The information provided by the functions 655 is then sent back to LLM 604 for synthesis of response 656.

One issue with conventional use of function calling is that typically, LLMs impose limits on an amount of data that can be supplied as context. These limits are imposed by a provider of the LLM and typically are not adjustable by end-users. This is referred to herein as a “context size” restriction or “context size” limit, and may also be referred to as an input size limit or maximum input size. If data produced by a tool exceeds the context size limit, sending it to the LLM for response synthesis will result in failure.

For conventional client applications, a suite of existing APIs not originally intended for LLM applications may be perfectly acceptable, as the client has plenty of local memory available to hold the data and then may programmatically perform further processing on it for specific use cases.

Attempting to integrate such APIs with an LLM can be problematic, since context size limitations may not have been a factor when during design. For example, with LLM applications, the conventional approach for function calling involves sending a tool's full response to the LLM. The reason for this being the open-ended nature in which the data may be utilized as part of response synthesis. When receiving a large set of structured data as context, the LLM may analyze the information to identify the individual items relevant to the user's question.

However, one common problem results from APIs that simply return a full dataset for some category of information in the external system, which may be too lengthy to satisfy context size restrictions of an LLM such that the LLM is unable to analyze such large data sets. Due to the context size constraint, function calling conventionally may be best suited for integration with tools that return small bits of information given a specific input (e.g., get_current_temperature(location)).

When the information required to answer a user question is only accessible via an API that returns a broad set of data, the conventional approach for reducing the amount of data sent back to the LLM would be to develop a wrapper function with parsing capability, such as a filtering capability. The challenge with this approach, however, is that the LLM must be able to map the related criteria from the user's question into a set of structured input parameters for the tool invocation message sent back to the application. Defining an API-specific data structure capable of representing all the different parsing and/or filtering possibilities expressible in natural language is difficult. Composing an associated description of the tool that enables the LLM to effectively map the natural language criteria into the data structure's fields would be equally challenging. Finally, code for the wrapper function would have to be written to perform the actual parsing or filtering based the structured input provided by the LLM.

In addition, some LLMs may have a context limit in the millions of characters or tokens, and so may not suffer the context-limit problem described above. However, when such an LLM is provided a large volume of output data from an API, such an LLM may nevertheless struggle to provide a relevant and accurate response because the LLM may have difficulty identifying small portions of information in the API output data that are relevant to a particular query in the midst of very large quantities of otherwise irrelevant information of the API output data.

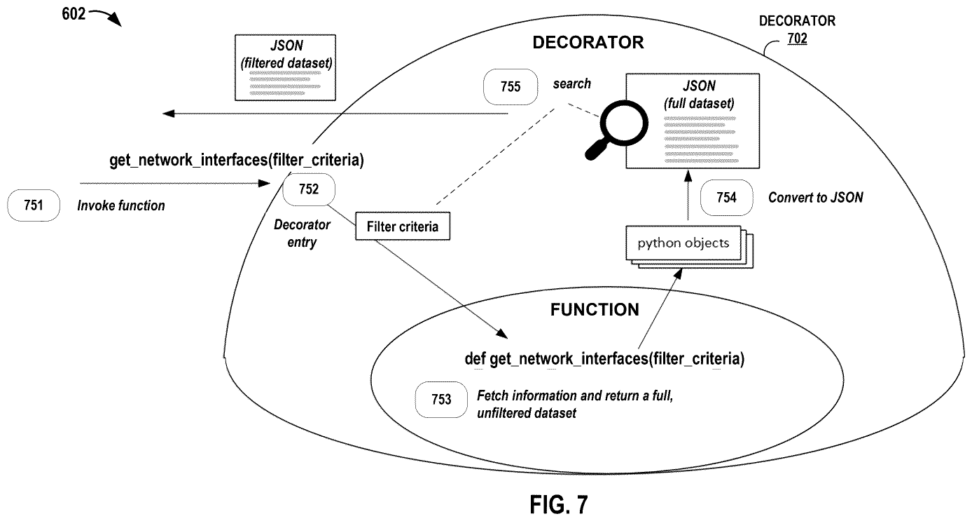

FIG. 7 is a block diagram illustrating an example of context-size agent 602 of FIG. 6 in further detail, in accordance with techniques described in this disclosure. Context-size agent 602 includes decorator 702. In some examples, decorator 702 may be an example implementation of context-size agent 102 of FIG. 1.

In accordance with techniques of the disclosure, a system is described herein that employs a generic mechanism applied to LLM function calling that enables data parsing and/or filtering to be performed locally by a client application, e.g., context-size agent 602. The motivation for this is to help address context limitation issues encountered when attempting to submit large amounts of data to LLM 604 for processing.

When receiving a large set of structured data as context, LLM 604 analyzes the information to identify individual items relevant to the user's question. The techniques of the disclosure recognize that in many cases, the user's question may include criteria that resolves to a small subset of information within the larger dataset. The techniques of the disclosure move the parsing and/or filtering of this criteria from LLM 604 to a local application, e.g., context-size agent 602, that interfaces between a user asking a query and LLM 604, which sends only the relevant subset of data to LLM 604 for response synthesis.

In an example implementation of the techniques of the disclosure, a Python-based solution is set forth in FIG. 7 that addresses the issues described above, allowing developers to easily add generic parsing and filtering support to any data retrieval API used in LLM function calling. This support does not necessarily eliminate the possibility of running into the context limit issue. However, the techniques disclosed herein may provide a strategy to help reduce the chance of context limit issues occurring, as well as to reduce the amount of API output data that is not relevant to the generation of a response by the LLM. An additional benefit of local parsing and/or filtering, however, is that it provides context-size agent 602, with an ability to understand when the dataset required to answer the user's question is too large for LLM 604 to ingest.

With the conventional approach to function calling, where a user supplies a full dataset to an LLM and delegates parsing and/or filtering to the LLM, the LLM may not have the knowledge to identify relevant portions of information within a very large dataset provided as part of a prompt. If the LLM request containing the full dataset exceeds the context limit, the LLM immediately rejects the prompt upon receipt. Because no further processing occurs, this would be the case even if the user's question contained criteria that resolves to a small subset of data. Not knowing the true size of the data needed to answer a question prevents the LLM from supporting additional strategies to deal with the context limit issue. For example, one strategy could be to intervene in the workflow and prompt the user with a message such as, “please provide additional criteria to reduce the scope of your request.” This would not make sense when the LLM performs parsing and/or filtering, as a full, raw dataset is always sent to the LLM.

From an application developer's perspective, the techniques of the disclosure enable local parsing and/or filtering support to be selectively applied to an existing python function by simply attaching a decorator and adding a parameter named, e.g., “filter_criteria,” as illustrated below:
@locally_filtered
def get_network_interfaces(filter_criteria: str)→List[NetworkInterface]
   #retrieve information from data source
   #and return a list of NetworkInterfaces
   . . .

The implementation of decorator 702 handles the details involved in supporting the filtering functionality. Although the solution needs the function's signature to include the filter_criteria parameter, there are no requirements for the function itself to do anything with it. It can be ignored, and the developer need only implement whatever code is necessary to return a full, raw dataset. Similar techniques may be applied using parsing functionality.

The overall design provided as an example herein is based upon a model in which a function's return data is transformed into a JSON document and then JSON path processing is utilized to query that JSON document to identify the parts matching the parsing and/or filtering criteria. This design enables decorator 702 to extract the natural language criteria from a user's questions and then convert that criteria into one or more equivalent JSON path query expressions.

Extracting criteria from a user's question (751), may be accomplished by leveraging LLM 604. Assuming the descriptions of the tools available contain adequate detail about the information the tools return, the reasoning logic of LLM 604 may determine how the individual parts of the criteria within a user's question map to each of the tools chosen for invocation. LLM 604 may need only to receive instruction to do so, and have that criteria included in the tool invocation information sent back to context-size agent 602. For example, the example text below provides part of a tool's description, and may be included in a prompt to LLM 604 to result in such a response:
“The filter_criteria parameter is specified as natural language text to select the information to be returned”

In some examples, the format of the tool-specific criteria provided to context-size agent 602 is a string of natural language text. The standard function calling workflow 752 passes this value as the filter_criteria parameter for the function call 753 (or “parsing_criteria” where such data is parsed). As mentioned earlier, however, the function's code does not do anything with that parameter. Instead, wrapper logic 753 of decorator 702 around the call uses the function's code. After invoking the wrapped target function and obtaining a result, decorator 702 proceeds with converting the returned data structure into a JSON representation 754. Decorator 702 then generates one or more JSON path expressions based on the natural language filter_criteria parameter value. Decorator 702 uses these to perform queries 755 to locate and extract the parts of the JSON document relevant to the user's original question. Decorator 702 then returns that information.

LLM 604 plays a key role in creating JSON path expressions from the natural language criteria. Given a JSON schema describing the JSON document and the natural language criteria, in some examples, decorator 702 makes a separate API call to LLM 604 requesting generation of one or more JSON path expressions that enable a search based on the criteria.

In alternate examples, decorator 702 transforms a function's return data into an XML document and then uses Xpath processing to query the XML document to identify parts matching the parsing and/or filtering criteria. This design enables decorator 702 to extract the natural language criteria from a user's questions and then convert that into one or more equivalent Xpath query expressions. The use of Xpath and XML may provide increased accuracy over the use of JSON path query expressions where LLM 604 is trained upon multiple versions or variations of JSON and/or JSON path queries or where the use of JSON.

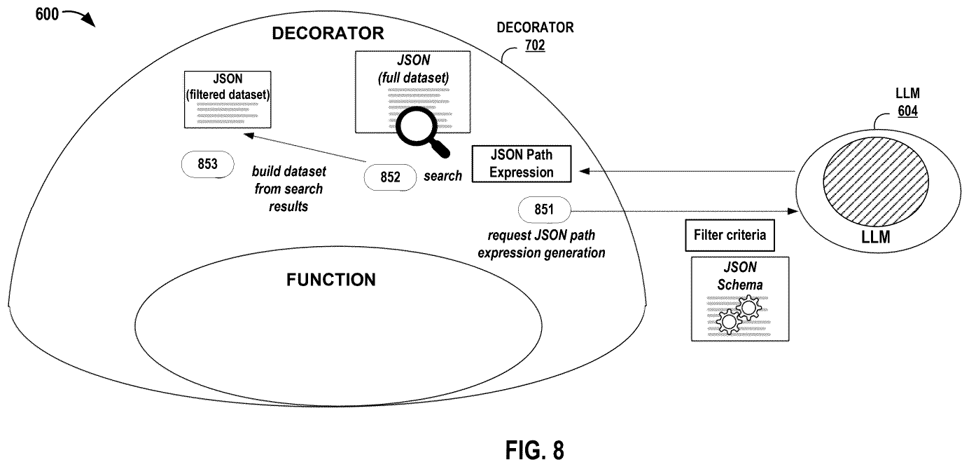

FIG. 8 is a block diagram illustrating example system 600 for performing function calling of FIG. 6 in further detail, in accordance with techniques described in this disclosure. As described above, decorator 702 may be an example implementation of context-size agent 102 of FIG. 1. As illustrated in the example of FIG. 8, decorator 702 provides a prompt to LLM 604 to perform JSON path expression generation (851) and receives the JSON path expression from LLM 604. Decorator 702 obtains a full JSON dataset by invoking one or more APIs 108. Decorator 702 applies the generated JSON path expression to search, parse, and/or filter the full JSON dataset (852). Decorator 702 builds parsed and/or filtered JSON dataset from the search results (853).

As the approach described in FIGS. 6-8 requires a JSON schema, the proposed techniques may provide two different means of satisfying this dependency. If the data structure returned by a function is based on a Pydantic model (available from https://docs.pydantic.dev/latest/) and has adequate descriptions for its fields, decorator 702 may use the data structure to automatically generate schema content. An alternative option, as shown below, is for developers to explicitly specify the schema content as a parameter to the decorator:
@locally_filtered(schema=“″”{
   “$schema”: “http://json-schema.org/draft-07/schema #”,
   “type”: “array”,
   “description”: “List of device network interfaces”,
   “items”: [
      {
         “description”: “Device network interface”,
         “type”: “object”,
         “properties”: {
         “label”: {
         “description”: “Name of the interface”,
         “type”: “string”
         },
      . . .
“″”)
def get_network_interfaces(filter_criteria: str)→List[NetworkInterface]
   #retrieve information from data source
   #and return a list of NetworkInterfaces
   . . .

An off-the-shelf LLM may be used to identify what APIs (and corresponding input parameters) should be invoked to produce data needed to answer a user's question. However, the resultant data may exceed a context size of LLM 604, and so may be unusable as an input to LLM 604.

The techniques of the disclosure may further leverage LLM 604 to provide parsing and/or filtering criteria that may be applied to the data obtained from the API invocations to obtain a more-relevant subset of data. Where the data obtained from the API invocations exceeds a context size of LLM 604, the smaller subset of data may satisfy the context size of LLM 604, and therefore may be provided as an input to LLM 604 for analysis. The disclosed techniques therefore enable one to use a context-size restricted LLM to analyze a data set that is larger than a context size permitted by the LLM.

The techniques of the disclosure may enable a context-size restricted LLM to use data sets larger than a permitted maximum context size of the LLM. In addition, the proposed idea may enable an LLM to provide more accurate responses by removing large amounts of unnecessary data from the prompt to the LLM, thereby enabling the LLM to analyze only the data pertinent to the user's query. Furthermore, the proposed idea may increase the efficiency of an LLM by allowing developers (and the LLM) to operate on smaller data sets while still receiving useful responses to queries, than conventional systems are able to provide.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system comprising:
processing circuitry in communication with storage media, the processing circuitry configured to:
obtain parsing criteria that is based on a natural language query received from a user device;
apply the parsing criteria to raw data obtained from one or more Application Programming Interfaces (APIs) to produce parsed data;
provide, to an Artificial Intelligence (AI) model, an input including (1) the natural language query received from the user device and (2) the parsed data to obtain a natural language answer to the natural language query; and
output the natural language answer.

2. The computing system of claim 1,
wherein the raw data indicates a state of a computer network, and
wherein the processing circuitry is further configured to generate network configuration data to configure the computer network based on the natural language answer.

3. The computing system of claim 1, wherein a context size of the AI model is less than a size of the raw data and greater than or equal to a size of the parsed data.

4. The computing system of claim 1,
wherein the parsing criteria comprises filtering criteria,
wherein to apply the parsing criteria to the raw data, the processing circuitry is configured to filter the raw data with the filtering criteria to generate filtered data,
wherein, to provide, to the AI model, the input, the processing circuitry is configured to provide, to the AI model, an input including (1) the natural language query received from the user device and (2) the filtered data to obtain a natural language answer to the natural language query, and
wherein a context size of the AI model is less than a size of the raw data and greater than or equal to a size of the filtered data.

5. The computing system of claim 1,
wherein the parsing criteria comprise one or more JavaScript Object Notation (JSON) path query expressions, and
wherein, to apply the parsing criteria to produce the parsed data, the processing circuitry is configured to:
generate, based on the raw data, a JavaScript Object Notation (JSON) document; and
apply the one or more JSON path query expressions to the JSON document to obtain the parsed data.

6. The computing system of claim 1,
wherein the parsing criteria comprise one or more Xpath query expressions, and
wherein, to apply the parsing criteria to produce the parsed data, the processing circuitry is configured to:
generating, based on the raw data, an Extensible Markup Language (XML) document from the raw data; and
applying the one or more Xpath query expressions to the XML document to obtain the parsed data.

7. The computing system of claim 1,
wherein the input comprises a first input,
wherein a plurality of APIs comprise the one or more APIs, and
wherein, to obtain the raw data from the one or more APIs, the processing circuitry is configured to:
provide, to the AI model, a second input including (i) the natural language query received from the user and (ii) a description of the plurality of APIs to obtain, from the AI model, a selection of the one or more APIs of the plurality of APIs and one or more parameters for invoking the selected one or more APIs; and
invoke the selected one or more APIs with the one or more parameters to obtain the raw data.

8. The computing system of claim 1,
wherein the input comprises a first input, and
wherein, to obtain the parsing criteria, the processing circuitry is configured to provide, to the AI model, a second input including (i) the natural language query received from the user and (ii) one or more schemas for the one or more APIs to obtain, from the AI model, the parsing criteria.

9. The computing system of claim 8 wherein the processing circuitry is configured to generate the one or more schemas for the one or more APIs from documentation for the one or more APIs.

10. The computing system of claim 8,
wherein the input comprises a first input, and
wherein the processing circuitry is configured receive a second input specifying the one or more schemas for the one or more APIs.

11. The computing system of claim 1,
wherein the input comprises a first input, and
wherein, to obtain the parsing criteria, the processing circuitry is configured to receive a second input from a user device, the second input specifying the parsing criteria.

12. The computing system of claim 1,
wherein the raw data comprises one or more of network telemetry data, network performance data, network management data, network configuration data, or network anomaly data,
wherein at least one of (i) the parsed data includes portions of the raw data associated with a network device of a plurality of network devices and excludes portions of the raw data associated with others of the plurality of network devices, or (ii) the parsed data includes portions of the raw data associated with a network interface of a plurality of network interfaces and excludes portions of the raw data associated with others of the plurality of network interfaces.

13. The computing system of claim 1, wherein the AI model comprises a language model.

14. A method comprising:
obtaining, by processing circuitry of a computing system, parsing criteria that is based on a natural language query received from a user device;
applying, by the processing circuitry, the parsing criteria to raw data obtained from one or more Application Programming Interfaces (APIs) to produce parsed data;
providing, by the processing circuitry, to an Artificial Intelligence (AI) model, an input including (1) the natural language query received from the user device and (2) the parsed data to obtain a natural language answer to the natural language query; and
outputting, by the processing circuitry, the natural language answer.

15. The method of claim 14,
wherein the raw data indicates a state of a computer network, and
wherein the method further comprises configuring the computer network based on the natural language answer.

16. The method of claim 14, wherein a context size of the AI model is less than a size of the raw data and greater than or equal to a size of the parsed data.

17. The method of claim 14,
wherein the parsing criteria comprises filtering criteria,
wherein applying the parsing criteria to the raw data comprises filtering the raw data with the filtering criteria to generate filtered data, and
wherein providing, to the AI model, the input comprises providing, to the AI model, an input including (1) the natural language query received from the user device and (2) the filtered data to obtain a natural language answer to the natural language query, and
wherein a context size of the AI model is less than a size of the raw data and greater than or equal to a size of the filtered data.

18. The method of claim 13,
wherein the input comprises a first input,
wherein a plurality of APIs comprise the one or more APIs, and
wherein obtaining the raw data from the one or more APIs comprises:
providing, to the AI model, a second input including (i) the natural language query received from the user and (ii) a description of the plurality of APIs to obtain, from the AI model, a selection of the one or more APIs of the plurality of APIs and one or more parameters for invoking the selected one or more APIs; and
invoking the selected one or more APIs with the one or more parameters to obtain the raw data.

19. The method of claim 13, wherein the AI model comprises a language model.

20. Non-transitory, computer-readable media comprising instructions that, when executed, cause processing circuitry to:
obtain parsing criteria that is based on a natural language query received from a user device;
apply the parsing criteria to raw data obtained from one or more Application Programming Interfaces (APIs) to produce parsed data;
provide, to an Artificial Intelligence (AI) model, an input including (1) the natural language query received from the user device and (2) the parsed data to obtain a natural language answer to the natural language query; and
output the natural language answer.
